(19) United States
(12) Patent Application Publication
(10) Pub. No.: US 2011/0268274 A1
(43) Pub. Date: Nov. 3, 2011

(54) Authentication and Key Establishment in Wireless Sensor Networks

(75) Inventors: Ying Qiu, Singapore (SG); Jianying Zhou, Singapore (SG); Joonsang Baek, Singapore (SG); Han Chiang Tan, Singapore (SG)

(73) Assignee: AGENCY FOR SCIENCE, TECHNOLOGY AND RESEARCH, South Tower, Singapore (SG)

(21) Appl. No.: 12/994,975

(22) PCT Filed: May 26, 2009
(86) PCT No.: PCT/SG2009/000185

§ 371 Date: Jul. 21, 2011

Related U.S. Application Data
(60) Provisional application No. 61/056,560, filed on May 28, 2008.

(51) Int. Cl. H04L 9/00

(52) U.S. Cl. 380/270

(57) ABSTRACT

A wireless sensor network (WSN) and a method for establishing a communication key between devices in a WSN. The WSN comprises a first device configured for sending a request message to a second device, the request identifying at least a third device for communication with which a communication key is intended, a first random number, and a first authentication code generated using a first secret key shared between the first and second devices; the second device configured for authenticating the first authentication code based on the first secret key, for generating the communication key based on the first secret key, the first random number, and a second random number using a hash function, for sending an approval message to the third device, the approval message comprising, in encrypted form based on a second secret key shared between the second and third device, the communication key and the first and second random numbers; the third device configured for decrypting the communication key and the first and second random numbers based on the second secret key and for sending a notice message to the first device, the notice message comprising the first and the second random numbers; and the first device configured for recalculating the communication key, based on the first secret key and said received first and second random numbers using said hash function.

### FIELD OF INVENTION

The invention broadly relates to a wireless sensor network (WSN) and to a method for establishing a communication key between devices in a WSN.

### BACKGROUND

A wireless sensor network (WSN) is a wireless network comprising spatially distributed autonomous devices using sensors to cooperatively monitor physical or environmental conditions, such as temperature, sound, vibration, pressure, motion or pollutants, at different locations.

There are many military, industrial and civilian applications that incorporate WSNs, including industrial process monitoring and control, machine health monitoring, environment and habitat monitoring, healthcare, home automation, and traffic control.

A WSN typically comprises of a large number of sensor nodes (fixed and/or mobile). Sensor nodes have limited capability in terms of computation, storage, communication and power harvesting/storage.

Security is crucial in WSNs and basic security mechanisms and protocols that can provide protection to the services and the information flow are needed. This means that the hardware layer should be protected against node compromise, communication channels should meet certain security goals (like confidentiality, integrity and authentication), and the protocols and services of the network should be robust against any possible interference. There are typically six main challenges in establishing good security: (i) wireless nature of communication, (ii) resource limitation on sensor nodes (minimal energy, computational and communicational capabilities), (iii) typically very large and dense WSN, (iv) lack of fixed infrastructure, (v) unknown network topology prior to deployment, (vi) high risk of physical attacks to unattended sensors.

Several proposed authentication schemes in wireless sensor networks include Radio Resource Testing, Random Key Pre-distribution, Time Synchronized Authentication (uTESLA), One Time Signature and Public Key Authentication. However, Radio Resource Testing can only be used for non-cryptographic means and while the Random Key Pre-distribution Scheme requires small computation and communication overheads, it fairs poorly in terms of node compromise and scalability. The uTESLA scheme has the disadvantages of time synchronization and delayed authentication while One Time Signature and Public Key Authentication schemes are costly in terms of computational, communication and storage overheads.

Common authentication protocols used in WSNs include the (simplified) Kerberos and the Eschenauer-Gligor protocols. The Kerberos protocol is a network authentication system that uses a trusted third party (or trusted authority) to authenticate two entities by issuing a shared session key between them. The messages exchanged in Kerberos can have a payload of several kilobytes, which makes the standard Kerberos protocol impractical for use in WSNs where data transfer is extremely costly in terms of energy consumption. A simplified Kerberos protocol is available but is nonetheless still costly in terms of energy consumption. The Eschenauer-Gligor protocol relies on probabilistic key sharing among the nodes of a random graph and uses a simple shared-key discovery protocol for key distribution. However, the main disadvantages of this protocol are low probability of connecting two sensor nodes and a large number of hops. Network performance deteriorates with an increase in hops.

For example, a WSN can be implemented in a hospital emergency room to track the movement of patients. When a patient with a mobile sensor node moves within the premises of a hospital, its “neighbourhood” and routing path constantly changes. The sensor node needs to constantly authenticate with its new “neighbours” and establish a key for secure communication.

In WSNs, power efficiency is another important consideration for choosing a routing path due to the low energy capabilities of sensor nodes. Some typical policies for selecting an efficient routing path include
1) Maximum Total Available Power (PA) Route: The route that has maximum total available power is preferred. The total available power is calculated by summing the available powers of each node along the route.
2) Minimum Energy (ME) Consumption Route: The route that consumes minimum energy to transmit the data packets between the base station and the sensor node is chosen.
3) Minimum Hop (MH) Route: The route that makes the minimum hops to reach the base station is preferred.
4) Maximum-Minimum PA Node Route: The route along which the minimum PA is larger than the minimum PAs of the other routes is preferred. This scheme precludes the risk of using up a sensor node with low PA much earlier than the others because they are on a route with nodes which have very high PAs.
   Since different policies employ different routing paths, different nodes are involved when different paths are chosen. A challenge is to establish a security channel with these multitude of “unknown” routes and how to authenticate with the nodes on these multitude “unknown” routes.

A need therefore exists to provide an authentication and key distribution protocol for use in a Wireless Sensor Network that seeks to address at least one of the abovementioned problems.

### SUMMARY

In accordance with a first aspect of the present invention there is provided a method for establishing a communication key between devices in a wireless sensor network (WSN), the method comprising the steps of sending a request message from a first device to a second device, the request identifying at least a third device for communication with which the communication key is intended, a first random number, and a first authentication code generated using a first secret key shared between the first and second devices; authenticating, at the second device, the first authentication code based on the first secret key; generating, at the second device, the communication key based on the first secret key, the first random number, and a second random number using a hash function; sending an approval message from the second device to the third device, the approval message comprising, in encrypted form based on a second secret key shared between the second and third device, the communication key and the first and second random numbers; decrypting, at the third device, the communication key and the first and second random numbers based on the second secret key; sending a notice message from the third device to the first device, the notice message comprising the first and the second random numbers; and recalculating, at the first device, the communication key, based on the first secret key and said received first and second random numbers using said hash function.

The first authentication code may be based on the first random number.

Recalculating, at the first device, the communication key may comprise verifying, at the first device, the first random number and a second authentication code, based on the first and second random numbers, received from the third device.

The method may further comprise assigning a lifetime to the communication key.

The method may further comprise storing, at the first and the third devices, said communication key in addition to one or more pre-stored shared keys.

In accordance with a second aspect of the present invention there is provided a wireless sensor network (WSN) comprising a first device configured for sending a request message to a second device, the request identifying at least a third device for communication with which a communication key is intended, a first random number, and a first authentication code generated using a first secret key shared between the first and second devices; the second device configured for authenticating the first authentication code based on the first secret key, for generating the communication key based on the first secret key, the first random number, and a second random number using a hash function, for sending an approval message to the third device, the approval message comprising, in encrypted form based on a second secret key shared between the second and third device, the communication key and the first and second random numbers; the third device configured for decrypting the communication key and the first and second random numbers based on the second secret key and for sending a notice message to the first device, the notice message comprising the first and the second random numbers; and the first device configured for recalculating the communication key, based on the first secret key and said received first and second random numbers using said hash function.

The first authentication code may be based on the first random number.

The first device may be configured for verifying the first random number and a second authentication key, based on the first and second random numbers, received from the third device.

The first and the third devices may be further configured to assign a lifetime to the communication key.

The first and the third devices may be further configured to store said communication key in addition to one or more pre-stored shared keys.

### BRIEF DESCRIPTION OF THE DRAWINGS

Example embodiments of the invention will be better understood and readily apparent to one of ordinary skill in the art from the following written description, by way of example only, and in conjunction with the drawings, in which:

FIG. 1 is a flow chart illustrating a key establishment and update scheme according to an embodiment of the present invention.

FIG. 2 is a flow chart illustrating the steps of connecting to another node in accordance with an embodiment of the present invention.

FIG. 3 is a flow chart illustrating steps of a distribution mode according to an embodiment of the present invention.

FIG. 4 is a flow chart illustrating the steps of a method for establishing a communication key between devices in a wireless sensor network (WSN) in accordance with another embodiment of the present invention.

FIG. 5 illustrates the data flow between elements of a WSN according to example embodiments of the invention.

FIG. 6 is a schematic drawing illustrating a sensor node being implemented using a computing device.

### DETAILED DESCRIPTION

An embodiment of the invention provides an authentication and key distribution protocol for use in a Wireless Sensor Network (WSN). The protocol preferably comprises 4 phases; shared key discovery; key establishment and update; authentication and encryption; and key revocation.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm, protocol or scheme is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “calculating”, “generating”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a general purpose computer or other device selectively activated or reconfigured by a computer program stored in the computer. The algorithms, protocols or schemes and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

The invention may also be implemented as hardware modules. More particular, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

In an example embodiment, when a sensor node moves within the range of a WSN, the sensor node may use a key discovery protocol to find a common key with another node. In this instance, it will be appreciated by a person skilled in the art that a random pair-wise key scheme can be employed. In this scheme, there is a large pool of symmetric keys. A random subset out of this pool is distributed to each sensor node. Once any two nodes find a common shared key from their own sets, the two nodes can start to communicate with each other. As each sensor node's memory can be limited, each sensor node may only store a small set of keys randomly selected from the key pool. If the common key is not found, a key establishment phase is advantageously initiated in the example embodiment.

Due to the limited storage capacity of sensor nodes, a common shared key-pair may not be available between a roaming sensor node and its new neighbouring nodes. This is especially common in the circumstance of a dynamic sensor node roaming within a large WSN (e.g. in hospitals, nuclear plants). Therefore, if a common key was not found during the shared key discovery phase, a key establishment phase can be initiated. During this phase, an efficient and scalable scheme is advantageously provided to establish and update the keys among nodes in the WSN.

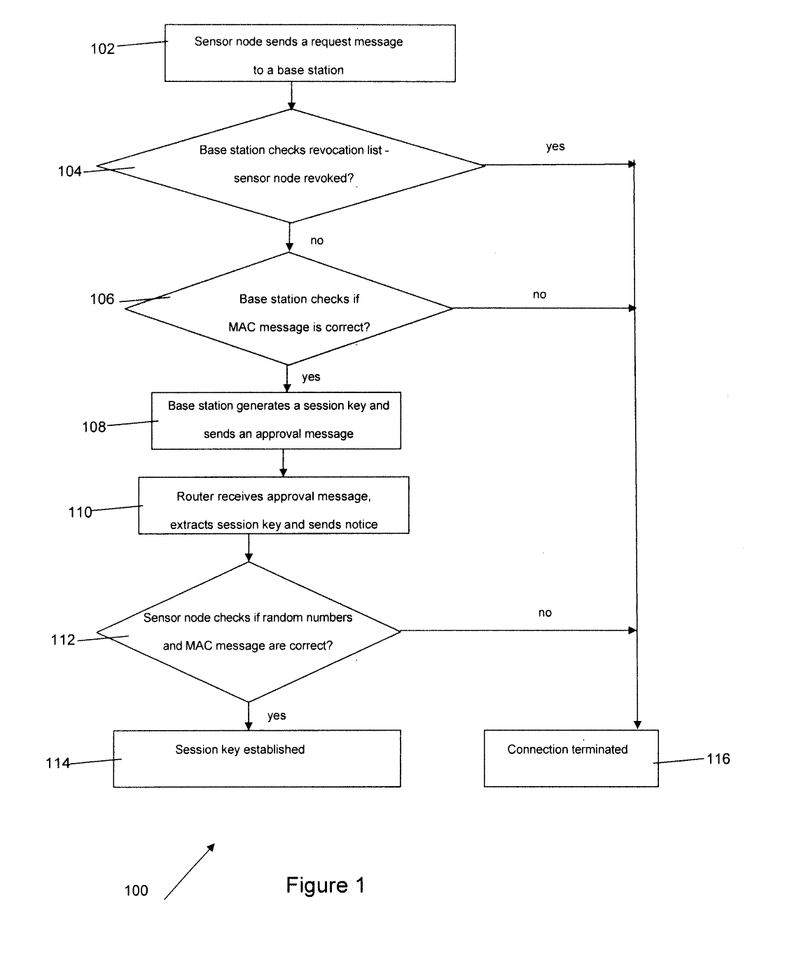

FIG. 1 is a flow chart, designated generally as reference numeral 100, illustrating a key establishment and update scheme according to an example embodiment of the present invention. When a sensor node moves to a new area in the WSN and wants to communicate with another node (router or cluster head) in the area with which it does not share a key, it first sends a request message to a base station, at step 102. The request message is in the following format:

req={src=ID,dst=BS,RT∥R₀∥MAC(K_{BN},ID∥RT∥R₀)},

where src and dst denote a source and destination address of a message, respectively. ID is a sensor node's identification, BS and RT are identifiers for the base station and the router (or cluster head), respectively. R₀ describes a random number generated by the sensor node. MAC indicates a message authentication code algorithm with a key and K_{BN} is a shared secret key between the base station and the sensor node.

After receiving the req message, the base station preferably checks its revocation list if the sensor node has been revoked, at step 104. If the sensor node is acceptable, the base station verifies the MAC message at step 106. If the sensor node has been revoked, connection is terminated, at step 116. If the MAC message is verified to be correct, the base station preferably generates a session key K_{NR} for the roaming sensor node and the router (or cluster head) at step 108. If the MAC message is not verified, connection is terminated, at step 116. The session key is in the following format:

K_{NR}=H(K_{BN},ID∥R₀∥R₁)

where H is a keyed one-way hash function, and R₁ is a random number selected by the base station. Also at step 108, the base station sends an approval message, appv, with the session key to the router or cluster head, in the following format:

appv={src=BS,dst=RT,E(K_{BT},ID∥R₀∥R₁∥K_{NR})}

where E is an encryption algorithm; K_{BT} is the shared secret key between the base station and the router or cluster head.

After receiving the approval message, appv, the router or cluster head decrypts the payload and extracts the session key K_{NR} and sends a notice to the sensor node at step 110. The notice is in the following format:

notice={src=RT,dst=ID,R₀∥R₁∥MAC(K_{NR},RT∥ID∥R₀∥R₁)}.

Upon receipt of the notice message, the sensor node extracts the random numbers R₀ and R₁. After checking if the received random number R₀ equates to the original R₀, the sensor node recalculates the session key

K_{NR}=H(K_{BN},ID∥R₀∥R₁)

and verifies the MAC value at step 112. If the MAC message is verified to be correct, the sensor node uses this session key for subsequent communication with the other node (router or cluster head) at step 114. If the random number R₀ or MAC message is incorrect, connection is terminated, at step 116. The node can be any other sensor node, router or cluster head in the WSN that the sensor node needs to establish communication with.

A node's identity (ID) information is used to authenticate and encrypt network traffic packets with example embodiments. In order to manage the keys in a WSN, every sensor node and router preferably maintains a table, called a key cache. Table 1 below shows an example of a key cache structure.

TABLE 1
Key Cache structure
Key Cache in Sensor Node N

| Node ID | Key | Key Lifetime |
|---|---|---|
| BS | K_{BN} | T_{BN} |
| nodeᵢ | K_{Ni} | T_{Ni} |
| . . . | . . . | . . . |
| node_{R} | R₀ | 0 |
| . . . | . . . | . . . |
| nodeⱼ | K_{Nj} | T_{Nj} |
| SharedKeyₓ | Kₓ | Tₓ |
| . . . | . . . | . . . |
| SharedKey_{y} | K_{y} | T_{y} |

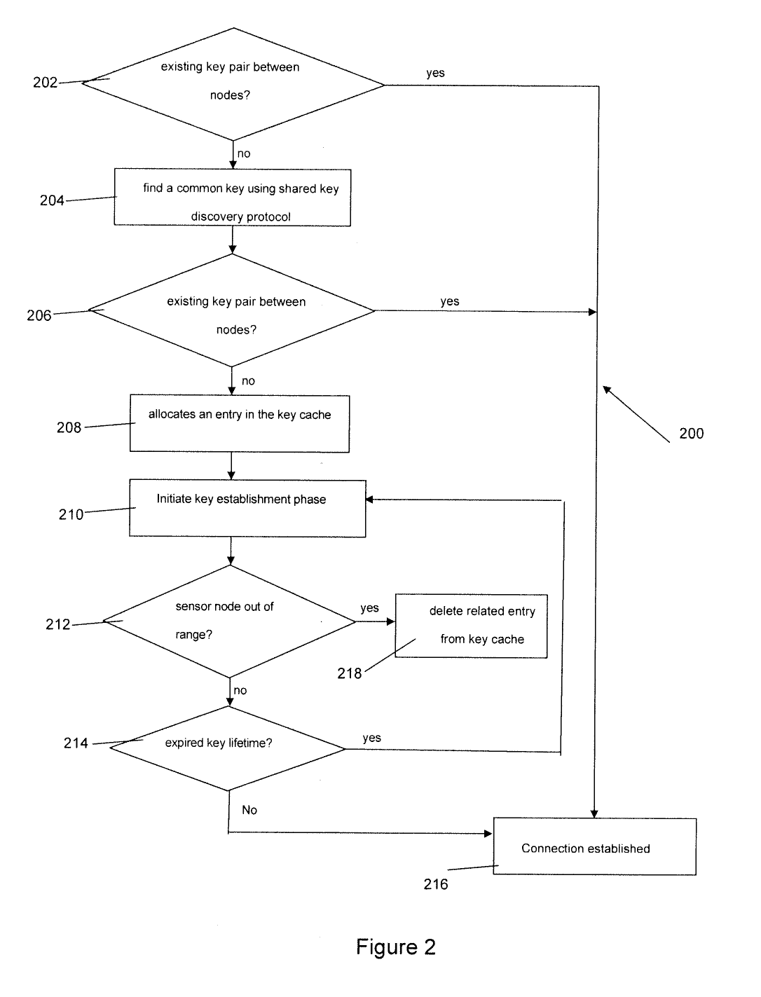

FIG. 2 is a flow chart, designated generally as reference numeral 200, illustrating the steps of connecting to another node in accordance with an embodiment of the present invention. For example, when a sensor node, node N, wants to connect to another sensor node, node R, it executes the following procedure:

At step 202, check if there is an existing key pair between the nodes (see nodeᵢ, . . . , nodeⱼ, in Table 1 above). If there is an existing key pair, connection is established at step 216.

At step 204, if there is no existing key pair, the shared key discovery protocol described in the key discovery phase above is initiated to find a common key between node N and node R based on the SharedKeys (see Table 1 above) in their key caches.

At step 206, if there is an existing key pair, connection is established at step 216. If there is still no common key between them, the sensor node allocates an entry in the key cache, and assigns Node ID as node_{R}, Key as the random number R₀ and Key Lifetime as 0, at step 208. (see Table 1 above) In the event that there is no memory space for adding a new entry, the oldest key (which may also expire soon) may be deleted first.

At step 210, the key establishment phase is then initiated. Upon receipt of the notice message and recalculated session key K_{NR}, the sensor node updates node R's key and key lifetime entries accordingly. The router or cluster head also updates/extends its key cache table with the session key K_{NR} accordingly. The key lifetime is an arbitrary value and can depend on the application. For example, a key lifetime can be set at 420 seconds in accordance with the mobile network specification as in IETF RFC 3775.

At step 212, a check is conducted to determine if the sensor node N has left the range of node R. At step 218, when the sensor node N leaves the range of node R, the sensor node deletes the related entry from its key cache table in the example embodiment in order to save memory space. While the sensor node N remains within range of node R, the process loops back to checking the expiry of the key lifetime at step 214.

At step 214, when the key lifetime expires, the sensor node preferably reinitiates the procedure of key establishment. If the key lifetime is still valid, connection is established at step 216.

If a node is compromised, the base station preferably revokes the related keys from the database and informs the relevant nodes. The base station also maintains a key table (see Table 2 below) that includes secret keys shared with all of the sensor nodes in the network. In the event that a node is compromised and revoked, its key lifetime entry is preferably marked as negative.

TABLE 2
Structure of a Key Table in a base station.
Key Table in Base Station

| Node ID | Key | Key Lifetime |
|---|---|---|
| nodeᵢ | K_{Bi} | T_{Bi} |
| . . . | . . . | . . . |
| nodeⱼ | K_{Bj} | T_{Bj} |

In an alternative embodiment of the present invention, there is provided an authentication and key distribution protocol for use in a Wireless Sensor Network (WSN) that comprises a distribution mode.

The distribution mode deploys a plurality of cluster heads as sub-basestations, recognizing that because cluster heads have better capability in terms of computation, storage and communication than normal sensor nodes, they can be employed as sub-basestations to reduce the number of hops required.

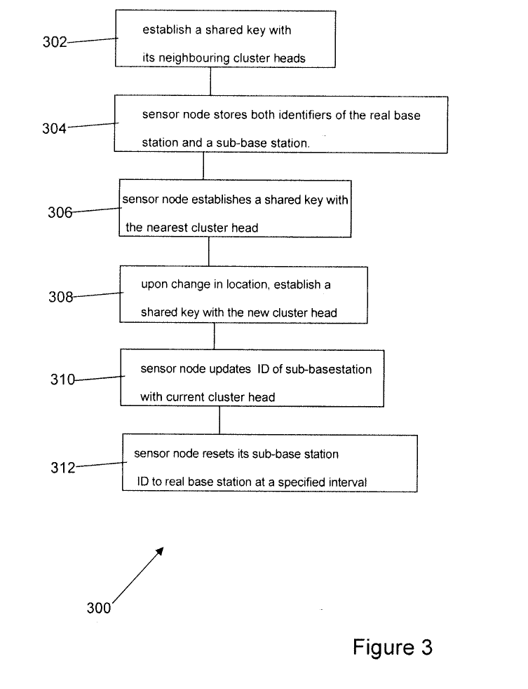

FIG. 3 is a flow chart, designated generally as reference numeral 300, illustrating steps of a distribution mode according to an embodiment of the present invention.

At step 302, each cluster head advantageously establishes a shared key with its neighbouring cluster heads after deployment. If a WSN's topology is known in advance, shared keys can preferably be established by embedding those keys in advance. Alternatively, if the topology is unknown in advance, the key establishment scheme described above for the key establishment phase can be used. Although the key establishment scheme may require more resources than simply embedding those keys in advance, as this is a one-time operation, the overheads may be acceptable.

At step 304, each sensor node stores two base station identities (IDs): one is the real base station ID; another is the sub-basestation (the cluster head) ID. Initially, the ID of the sub-basestation is preferably designated as the real base station ID.

At step 306, after deployment, a sensor node preferably establishes a shared key with the nearest cluster head using the key establishment scheme outlined in the key establishment phase described above.

At step 308, when the sensor node moves within the WSN, the same key establishment scheme is used to establish a shared key with the new cluster head, via the sub-basestation (cluster head) rather than the real base station.

At step 310, after successfully establishing the keys, the sensor node updates the ID of sub-basestation with the current cluster head.

At step 312, for security, each sensor node preferably resets its sub-basestation ID to real base station at a specified interval (for example, 420 seconds, a few hours or days, depending on the application) and re-establishes keys with its nearest cluster heads via the real base station. If the basestation does not receive any request from the sensor node, it considers the sensor node compromised.

In a WSN, an increase in the number of hops between 2 nodes can lead to poorer network traffic performance and more energy consumption. The distribution mode advantageously provides an efficient and low energy cost solution for establishing a shared key. The distribution mode may advantageously provide better security as it can immediately block and revoke compromised nodes.

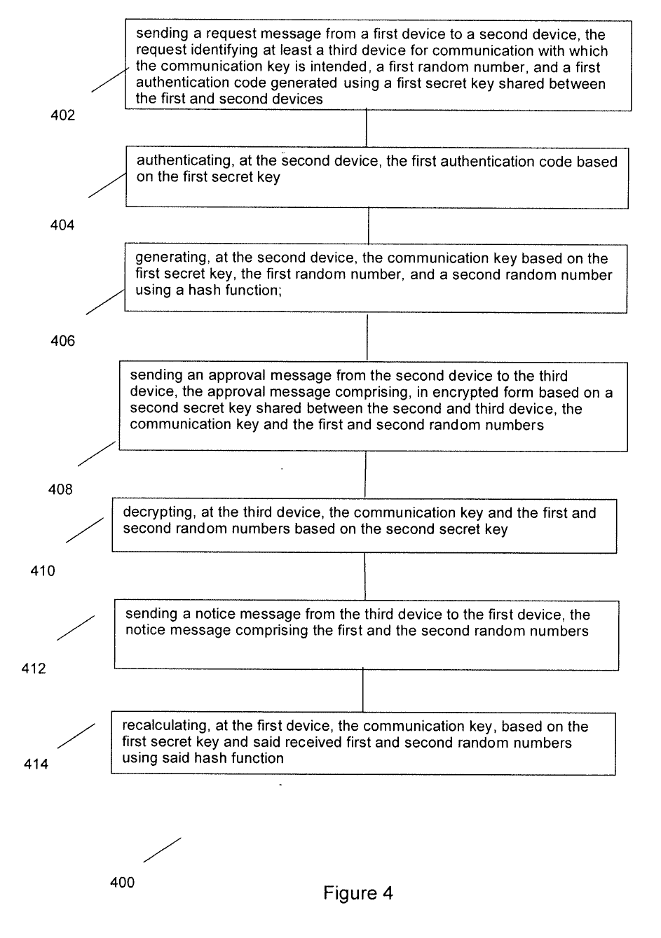

FIG. 4 is a flow chart, designated generally as reference numeral 400, illustrating the steps of a method for establishing a communication key between devices in a wireless sensor network (WSN) in accordance with another embodiment of the present invention.

At step 402, a request message is sent from a first device to a second device, the request identifying at least a third device for communication with which the communication key is intended, a first random number, and a first authentication code generated using a first secret key shared between the first and second devices. At step 404, the first authentication code is authenticated, at the second device, based on the first secret key. At step 406, the communication key is generated, at the second device, based on the first secret key, the first random number, and a second random number using a hash function.

At step 408, an approval message is sent from the second device to the third device, the approval message comprising, in encrypted form based on a second secret key shared between the second and third device, the communication key and the first and second random numbers. At step 410, the communication key and the first and second random numbers are decrypted, at the third device, based on the second secret key. At step 412, a notice message is sent from the third device to the first device, the notice message comprising the first and the second random numbers. At step 414, the communication key is recalculated, at the first device, based on the first secret key and said received first and second random numbers using said hash function. The use of the first and second random numbers can advantageously prevent replay attacks.

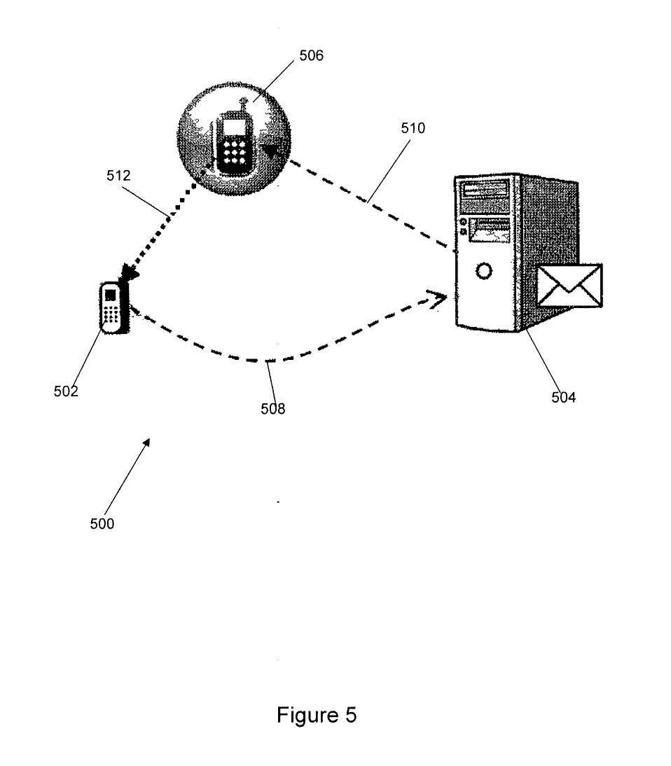

FIG. 5 is a schematic illustration of a WSN 500 according to example embodiments of the invention. The WSN 500 comprises a mobile sensor node 502, a base station (or cluster head) 504 and router 506. It will be appreciated by a person skilled in the art that the type and number of devices in FIG. 5 are only for illustrative purposes. A WSN may comprise different types of devices in different numbers. The devices 502, 504 and 506 are configured for generating, transmitting, receiving, processing and authenticating data according to the description above. (see FIGS. 1-4 and their corresponding description).

In summary, sensor node 502 is configured for sending a request message, req, to the base station 504 (see arrow 508). The base station 504 is configured for receiving, processing and authenticating the request message and for sending an approval message, appv, to the router 506 (see arrow 510). The router 506 is configured for receiving, processing and authenticating the approval message and sending a notice to the sensor node 502 (see arrow 512). The sensor node is configured to receive, process and authenticate the notice. Thereafter, the sensor node 502 and the router 506 can advantageously securely communicate.

It will be appreciated by a person skilled in the art that the mobile sensor node 502, the base station (or cluster head) 504 and the router 506 can be implemented in a number of different ways, for example, as a dedicated hardware module or a computer device in order to execute the relevant generating, transmitting, receiving, processing and authenticating steps described above.

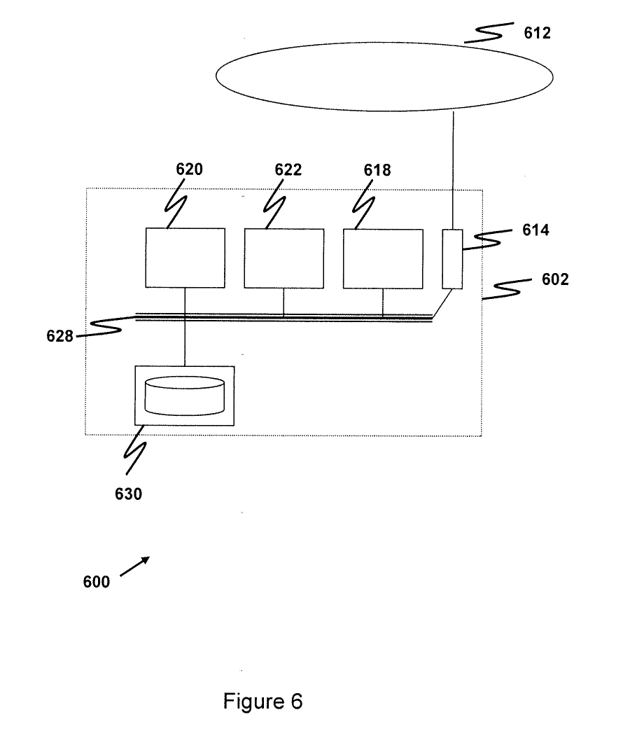

FIG. 6 is a schematic drawing illustrating, for example, the sensor node 502 being implemented using a computing device 600. It may be implemented as software, such as a computer program being executed within the computer system 600, and instructing the computer system 600 to conduct the method of the example embodiment.

The computer system 600 comprises a computer module 602 and is connected to a wireless sensor network 612 via a suitable transceiver device 614. The computer module 602 in the example includes a processor 618, a Random Access Memory (RAM) 620 and a Read Only Memory (ROM) 622. The components of the computer module 602 typically communicate via an interconnected bus 628 and in a manner known to the person skilled in the relevant art.

The application program is typically supplied to the user of the computer system 600 encoded on a data storage medium such as a CD-ROM or flash memory carrier and read utilising a corresponding data storage medium drive of a data storage device 630. The application program is read and controlled in its execution by the processor 618. Intermediate storage of program data may be accomplished using RAM 620.

It will be appreciated that both the base station 504 and router 506 can be implemented using a computing device substantially similar to that illustrated in FIG. 6 above.

The protocol provided by embodiments of the present invention may advantageously save communication energy compared to existing solutions. Example embodiments of the present invention may also advantageously decrease the number of hops.

The Eschenauer-Gligor protocol's main disadvantages are low connective probability and a large number of hops. For instance, a WSN with 10 000 nodes expects almost 14 degrees of node to ensure 99% probability of connection. If 99.999% probability is desired, 20 degrees of node is expected. However, network performance deteriorates with an increase in hops. For example, a 7 hops network typically has a very low throughput of less than 2 Kbps. Comparatively, the protocol in accordance with embodiments of the present invention may advantageously require about 3 hops between a sensor node and its nearest cluster head. As such, a higher connective probability can be achieved with less memory cost, without considerable increase in communication.

The protocol according to embodiments of the present invention is suitable for both static and dynamic WSNs. Any pair of nodes can advantageously establish a shared key for secure communication. A roaming sensor node preferably deals only with its closest node (router or cluster head) for security. There is advantageously no need to change the routing path to the base station. In addition, a base station may manage a revocation list for lost or compromised roaming sensor nodes. The protocol according to embodiments of the present invention also facilitates scalability and resilience against node compromise.

Example embodiments preferably enable a moving sensor node in a WSN to change its attached routers frequently. At the same time, the attached routers preferentially ensure that the joining moving sensor node is not a malicious sensor node. In addition, the moving sensor node also preferably establishes a security tunnel with the new route. The security scheme is also preferably highly resilient and scalable. A typical WSN may contain from hundreds to thousands of sensor nodes, therefore any scheme used should preferably be adaptable to such scales and resilient against node compromise.

It will be appreciated by a person skilled in the art that numerous variations and/or modifications may be made to the present invention as shown in the embodiments without departing from a spirit or scope of the invention as broadly described. The embodiments are, therefore, to be considered in all respects to be illustrative and not restrictive.

1. A method for establishing a communication key between devices in a wireless sensor network (WSN), the method comprising the steps of:
sending a request message from a first device to a second device, the request identifying at least a third device for communication with which the communication key is intended, a first random number, and a first authentication code generated using a first secret key shared between the first and second devices;
authenticating, at the second device, the first authentication code based on the first secret key;
generating, at the second device, the communication key based on the first secret key, the first random number, and a second random number using a hash function;
sending an approval message from the second device to the third device, the approval message comprising, in encrypted form based on a second secret key shared between the second and third device, the communication key and the first and second random numbers;
decrypting, at the third device, the communication key and the first and second random numbers based on the second secret key;
sending a notice message from the third device to the first device, the notice message comprising the first and the second random numbers; and
recalculating, at the first device, the communication key, based on the first secret key and said received first and second random numbers using said hash function.

2. The method as claimed in claim 1, wherein the first authentication code is based on the first random number.

3. The method as claimed in claim 1, wherein recalculating, at the first device, the communication key comprises verifying, at the first device, the first random number and a second authentication key, based on the first and second random numbers, received from the third device.

4. The method as claimed in claim 1, further comprising assigning a lifetime to the communication key.

5. The method as claimed in claim 1, further comprising storing, at the first and the third devices, said communication key in addition to one or more pre-stored shared keys.

6. A wireless sensor network (WSN) comprising:
a first device configured for sending a request message to a second device, the request identifying at least a third device for communication with which a communication key is intended, a first random number, and a first authentication code generated using a first secret key shared between the first and second devices;
the second device configured for authenticating the first authentication code based on the first secret key, for generating the communication key based on the first secret key, the first random number, and a second random number using a hash function, for sending an approval message to the third device, the approval message comprising, in encrypted form based on a second secret key shared between the second and third device, the communication key and the first and second random numbers;
the third device configured for decrypting the communication key and the first and second random numbers based on the second secret key and for sending a notice message to the first device, the notice message comprising the first and the second random numbers; and
the first device configured for recalculating the communication key, based on the first secret key and said received first and second random numbers using said hash function.

7. The WSN as claimed in claim 6, wherein the first authentication code is based on the first random number.

8. The WSN as claimed in claim 6, wherein the first device is configured for verifying the first random number and a second authentication key, based on the first and second random numbers, received from the third device.

9. The WSN as claimed in claim 6, wherein the first and the third devices are further configured to assign a lifetime to the communication key.

10. The WSN as claimed in claim 6, wherein the first and the third devices are further configured to store said communication key in addition to one or more pre-stored shared keys.
